(19) United States
(12) Patent Application Publication
(10) Pub. No.: US 2005/0220230 A1
(43) Pub. Date: Oct. 6, 2005

(54) Carrier detecting method and carrier detecting circuit

(75) Inventor: Yosuke Fukuda, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/090,207

(22) Filed: Mar. 28, 2005

(30) Foreign Application Priority Data
Mar. 31, 2004 (JP) 2004-105640

(51) Int. Cl. H04L 27/14

(52) U.S. Cl. 375/343

(57) ABSTRACT

A carrier detecting circuit in a receiver of a wireless device has a circuit for determining a power value of a received signal, a circuit for determining a correlation value between a preamble included in the received signal and a predetermined preamble pattern which characterizes a communication system to which the wireless device belongs, a circuit for judging that a carrier is detected and tentatively instructing a demodulating circuit of the wireless device to start a demodulating process of a signal if the power value exceeds a first threshold value or the correlation value exceeds a second threshold value, and a circuit for instructing the demodulating circuit to stop the demodulating process which has tentatively been started if it is judged that the correlation value does not exceed the second threshold value during a predetermined first time interval.

### BACKGROUND OF THE INVENTION

1. Field of the Invention

The present invention relates to a method of and a circuit for detecting a carrier to detect the reception of a signal in a wireless device.

2. Description of the Related Art

There is known a burst signal transmission system such as a wireless LAN (Local Area Network) system employing a CSMA/CA (Carrier Sense Multiple Access with Collision Avoidance) scheme as a wireless access scheme. In such a burst signal transmission system, a base station can communicate, at a time, with only one of terminals belonging to the base station.

In the burst signal transmission system, the base station normally gives terminal identification information to the terminals belonging to the base station when a link is established. When the base station is to send a burst signal to one of the terminals belonging to the base station, the base station adds identification information for the terminal to the burst signal, and sends the burst signal to the terminal. All the terminals measure a received signal power level (hereinafter referred to as “RSSI” (Received Signal Strength Indicator)) of the burst signal transmitted from the base station, compare the measured RSSI value with a predetermined decision threshold value (hereinafter referred to as “carrier detection threshold value”), and, if the measured RSSI value exceeds the carrier detection threshold value, judges that a carrier is detected and starts a demodulating process of the received signal. If the measured RSSI value is smaller than the carrier detection threshold value, the terminals judge that a carrier is not detected and does not start the demodulating process.

When a terminal judges that a carrier is detected, it starts a demodulating process of a received signal. In the demodulating process, the terminal detects a known fixed pattern, called a preamble signal, added to the beginning of the burst signal, i.e., detects symbol timing, to synchronize itself with the burst signal. After the symbol timing detection, the terminal demodulates the data of the burst signal subsequent to the preamble signal, and determines whether the burst signal is addressed to the terminal or not based on the terminal identification signal added to the burst signal. If the burst signal is addressed to the terminal, then the terminal goes on to demodulate the data of the burst signal subsequent to the terminal identification signal. If the burst signal is not addressed to the terminal, then the terminal stops demodulating the data of the burst signal subsequent to the terminal identification signal.

The above conventional carrier detecting process is disclosed in Japanese laid-open patent publication No. 2000-156666 (JP. P2000-156666A), for example.

According to the above conventional carrier detecting process, however, even if the terminal receives an interference power, when the measured RSSI value exceeds the carrier detection threshold value, the terminal starts the demodulating process. Since the terminal is unable to determine whether the signal is addressed to its own system or not until at least the symbol timing detection is finished, the signal demodulating process is needlessly carried out until the end of the symbol timing detection. As a result, the demodulating circuit operates unnecessarily, lowering the communication efficiency. The term “its own system”referred to above represents a communication system to which the terminal belongs. In such a communication system, terminals or a terminal and a base station communicate with each other according to a communication scheme and a signal format which are prescribed by corresponding standards.

### SUMMARY OF THE INVENTION

It is an object of the present invention to provide a method of detecting a carrier by determining whether a received signal is a signal addressed to the own system or not until symbol timing detection is finished for thereby preventing communication efficiency from being lowered due to unnecessary operation of a demodulating circuit.

Another object of the present invention is to provide a carrier detecting circuit which can determine whether a received signal is a signal addressed to the own system or not until symbol timing detection is finished thereby preventing communication efficiency from being lowered due to unnecessary operation of a demodulating circuit.

According to a first aspect of the present invention, there is provided a method of detecting a carrier in a receiver of a wireless device, comprising the steps of determining a power value of a received signal and comparing the power value with a predetermined first threshold value, determining a correlation value between a preamble included in the received signal and a predetermined preamble pattern which characterizes a communication system to which the wireless device belongs, and comparing the correlation value with a predetermined second threshold value, judging that a carrier is detected and tentatively starting a demodulating process of a signal if the power value exceeds the first threshold value or the correlation value exceeds the second threshold value, and stopping the demodulating process which has tentatively been started if it is judged that the correlation value does not exceed the second threshold value during a predetermined first time interval from the time when it is judged that a carrier is detected.

By calculating the correlation value and comparing the correlation value with the second threshold value, it is possible to determine whether the received signal is addressed to an own system to which the wireless device belongs. With the method according to the first aspect, since the correlation value can generally be calculated and compared with the second threshold value in a time shorter than a time required for symbol timing detection, if it is judged that the received signal is not addressed to the own system based on the correlation value, then the demodulating process which has tentatively been started is stopped, and will not needlessly be performed up to symbol timing detection. Furthermore, since a demodulating circuit is instructed to start the demodulating process tentatively when either one of the power value and the correlation value exceeds the first threshold value or the second threshold value, the signal demodulating process is not delayed in the case that a signal addressed to the own system is received.

According to a second aspect of the present invention, there is provided a method of detecting a carrier in a receiver of a wireless device, comprising the steps of determining a power value of a received signal and comparing the power value with a predetermined first threshold value, determining a correlation value between a preamble included in the received signal and a predetermined preamble pattern which characterizes a communication system to which the wireless device belongs, and comparing the correlation value with a predetermined second threshold value, and starting a demodulating process of a signal if the power value exceeds the first threshold value and the correlation value exceeds the second threshold value.

With the method according to the second aspect, since a demodulating circuit of the receiver is instructed to start the demodulating process of the signal only when both the power value and the correlation value exceed the respective first and second threshold values. If the received signal is addressed to the system, then though the demodulating process of the signal may possibly be delayed, the demodulating process will not needlessly be carried out, unlike the method according to the first aspect.

According to a third aspect of the present invention, there is provided a carrier detecting circuit provided in a receiver of a wireless device, comprising means for determining a power value of a received signal, means for comparing the power value with a predetermined first threshold value, means for determining a correlation value between a preamble included in the received signal and a predetermined preamble pattern which characterizes a communication system to which the wireless device belongs, means for comparing the correlation value with a predetermined second threshold value, means for judging that a carrier is detected and tentatively instructing a demodulating circuit of the wireless device to start a demodulating process of a signal if the power value exceeds the first threshold value or the correlation value exceeds the second threshold value, and means for instructing the demodulating circuit to stop the demodulating process which has tentatively been started if it is judged that the correlation value does not exceed the second threshold value during a predetermined first time interval from the time when it is judged that a carrier is detected.

According to a fourth aspect of the present invention, there is provided a carrier detecting circuit provided in a receiver of a wireless device, comprising means for determining a power value of a received signal, means for comparing the power value with a predetermined first threshold value, means for determining a correlation value between a preamble included in the received signal and a predetermined preamble pattern which characterizes a communication system to which the wireless device belongs, means for comparing the correlation value with a predetermined second threshold value, and means for instructing a demodulating circuit of the wireless device to start a demodulating process of a signal if the power value exceeds the first threshold value and the correlation value exceeds the second threshold value.

According to the present invention, inasmuch as it is determined whether the received signal is addressed to the own system based on the correlation of a preamble which can generally be determined in a time shorter than the time required for symbol timing detection, the demodulating circuit is prevented from operating needlessly.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a block diagram of a receiver incorporating a carrier detecting circuit according to an embodiment of the present invention;

FIG. 2 is a flowchart of an operation sequence of the receiver shown in FIG. 1.

### DETAILED DESCRIPTION OF THE PREFERRED EMBODIMENTS

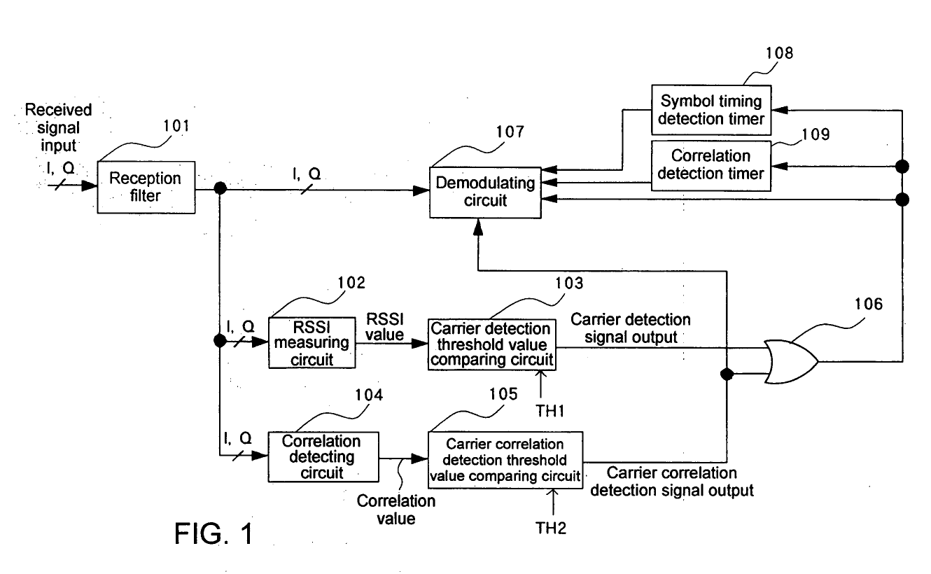

As shown in FIG. 1, the receiver includes reception filter 101 RSSI measuring circuit 102, carrier detection threshold value comparing circuit 103, correlation detecting circuit 104, carrier correlation detection threshold value comparing circuit 105, OR circuit 106, demodulating circuit 107, symbol timing detection timer 108, and correlation detection timer 109. The carrier detecting circuit is constructed of RSSI measuring circuit 102, carrier detection threshold value comparing circuit 103, correlation detecting circuit 104, carrier correlation detection threshold value comparing circuit 105, OR circuit 106, and correlation detection timer 109.

Reception filter 101 functions as a channel selection filter, and comprises a digital filter which is of an identical arrangement for I(in-phase) and Q (quadrature) components. Reception filter 101 may be an FIR (Finite Impulse Response) filter or an IIR (Infinite Impulse Response) filter. Of these filters, the FIR filter is better in terms of stability. For designing an FIR filter, it is natural to select an optimum window function and optimize a roll-off factor for obtaining desired frequency characteristics. In addition, it is also necessary to add an analog filter to the FIR filter. Reception filter 101 is supplied with detected orthogonal components (I and Q signal components) that are converted into digital signals by a 10-bit or 12-bit analog-to-digital (A/D) converter. In this embodiment, each of the I and Q signal components comprises 12-bit digital data, for example. Reception filter 101 supplies the I and Q signal components of the received signal to RSSI measuring circuit 102, correlation detecting circuit 104, and demodulating circuit 107.

RSSI measuring circuit 102 receives the I and Q components that have passed through reception filter 101, and calculates a moving average of the electric power, i.e., the RSSI signal, determined from the amplitudes of the I and Q signal cornponents. A moving average time window may be set to the period of a preamble signal that is added to the beginning of a frame or a packet.

The preamble signal is a periodic signal which is prescribed as a known fixed pattern according to standards, such as IEEE802.11a or HIPERLAN/2, for example, for burst signal transmission systems. The preamble signal is usually added to the beginning of a frame or a packet when the burst signal is transmitted. For example, according to IEEE802.11a, short preamble signal S(−26, 26) and long preamble signal L (−26, 26) are specified as a known fixed pattern as follows:
S(−26, 26)=(13/6)^{1/2}×{0, 0, 1+j, 0, 0, 0, −1−j, 0, 0, 0, 1+j, 0, 0, 0, −1−j, 0, 0, 0, −1−j, 0, 0, 0, 1+j, 0, 0, 0, 0, 0, 0, 0, −1−j, 0, 0, 0, −1−j, 0, 0, 0, 1+j, 0, 0, 0, 1+j, 0, 0, 0, 1+j, 0, 0, 0, 1+j, 0, 0};
L(−26, 26)={1, 1, −1, −1, 1, 1 , −1, 1, −1, 1, 1, 1, 1, 1, 1, −1, −1, 1, 1, −1, 1, −1, 1, 1, 1, 1, 0, 1, −1, −1, 1, 1,−1, 1, −1, 1, −1, −1, −1, −1, −1, 1, 1,−1, −1, 1, −1, 1, −1, 1, 1, 1, 1}.

In a communication system according to IEEE802.11a which employs an OFDM (Orthogonal Frequency Dividing Multiplexing) scheme as a modulation process, short preamble signal S(−26, 26) uses 12 of 52 subcarriers. An FFT (Fast Fourier Transform) period is set to 3.2 microseconds. A signal in the frequency domain is subjected to IFFT (Inverse Fast Fourier Transform) at the set FFT period, and then the signal is subjected to QPSK (Quadrature Phase Shift Key) to obtain a repetitive signal composed of ten fixed pattern signals each having a period of 0.8 microsecond. Long preamble signal L(−26, 26) is of a fixed pattern having a 20 FDM symbol lengths, i.e., 0.8 microsecond, according to BPSK (Binary Phase Shift Keying).

According to IEEE802.11a, the short preamble signal should preferably be used for signal detection, AGC (Automatic Gain Control) activation, carrier frequency error coarse adjustment, and symbol timing detection. The long preamble signal should preferably be used for channel estimation and carrier frequency error fine adjustment. Therefore, the moving averaging time window in RSSI measuring circuit 102 is set to 0.8 microsecond.

RSSI measuring circuit 102 delivers a calculated RSSI value to carrier detection threshold value comparing circuit 103.

Carrier detection threshold value comparing circuit 103 receives the RSSI value from RSSI measuring circuit 102, and compares the received RSSI value with a predetermined threshold value (TH1). If the RSSI value exceeds threshold value TH1, then carrier detection threshold value comparing circuit 103 determines that the carrier is detected and suppies a carrier detection signal to OR circuit 106.

Correlation detecting circuit 104 receives the I and Q components that have passed through reception filter 101, and calculates a correlation value between the short preamble included in the received signal and a predetermined preamble pattern. The predetermined preamble pattern is a pattern that is related to a preamble used in the own system. Correlation detecting circuit 104 may be any circuits insofar as they are capable of calculating the correlation value with the fixed pattern of the short preamble. For example, correlation detecting circuit 104 may be a normalizing circuit for normalizing a correlation value with moving average power, using a main filter comprising a matching filter having a fixed pattern on a time axis as coefficients, or a combination of a complex IIR filter operable in the same period as the periodic signal for improving an SN ratio, and an FIR filter (moving average filter) for collecting the power of delayed waves that are dispersed in time due to a fading environment for improving an SN ratio. Alternatively, correlation detecting circuit 104 may be a circuit for delaying an input signal for the time of the period (0.8 microsecond) and sequentially correlating the presently received signal and the signal received in one preceding period. Correlation detecting circuit 104 supplies the calculated correlation value to carrier correlation detection threshold value comparing circuit 105.

Carrier correlation detection threshold value comparing circuit 105 receives the correlation value from correlation detecting circuit 104. If the received correlation value exceeds a predetermined threshold value (TH2), then carrier correlation detection threshold value comparing circuit 105 judges that a carrier correlation is detected, i.e., the received signal is addressed to the own system, and supplies a carrier correlation detection signal to OR circuit 106 and demodulating circuit 107. Carrier correlation detection threshold value comparing circuit 105 may judge that a carrier correlation is detected when it detects even one short preamble pattern or when it detects two or three short preamble patterns. In terms of the processing time, it is practical for carrier correlation detection threshold value comparing circuit 105 to judge that a carrier correlation is detected when it detects one short preamble pattern.

OR circuit 106 receives the carrier detection signal from carrier detection threshold value comparing circuit 103, and also receives the carrier correlation detection signal from carrier correlation detection threshold value comparing circuit 105. When OR circuit 106 receives either one of the carrier detection signal and the carrier correlation detection signal, the OR circuit 106 tentatively judges that a carrier is detected, and outputs a signal for instructing demodulating circuit 107 to start a signal demodulating process. When OR circuit 106 judges that a carrier is detected, it outputs a signal for instructing symbol timing detection timer 108 and correlation detection timer 109 to start their counting processes.

When symbol timing detection timer 108 receives the counting start signal from OR circuit 106, symbol timing detection timer 108 starts measuring a preset time. When symbol timing detection timer 108 finishes measuring the preset time, it delivers a signal representing the end of the counting process to demodulating circuit 107. The time to be measured by symbol timing detection timer 108 is slightly longer than a time that is consumed for symbol timing detection when a signal addressed to the own system is detected. In the present embodiment, the time to be measured by symbol timing detection timer 108 is set to about 12 microseconds.

When correlation detection timer 109 receives the counting start signal from OR circuit 106, correlation detection timer 109 starts measuring a preset time. When correlation detection timer 109 finishes measuring the preset time, it delivers a signal representing the end of the counting process to demodulating circuit 107. The time to be measured by correlation detection timer 109 is slightly longer than a time that is consumed for correlation detection when a signal addressed to the own system is detected. In general, the time to be measured by correlation detection timer 109 is shorter than the tome that is consumed for the symbol timing detection. In the present embodiment, the time to be measured by correlation detection timer 109 is set to about 6 microseconds.

When demodulating circuit 107 receives the signal for starting the demodulating process from OR circuit 106, demodulating circuit 107 tentatively starts demodulating the signal received from reception filter 101. However, if demodulating circuit 107 does not receive a carrier correlation detection signal from carrier correlation detection threshold value comparing circuit 105 before it receives the signal representing the end of the counting process from correlation detection timer 109, then demodulating circuit 107 judges that the signal received by the receiver is not addressed to the own system, and temporarily stops the demodulating process which has tentatively been started. Furthermore, if symbol timing detection is not finished before it receives the signal representing the end of the counting process from symbol timing detection timer 108, then demodulating circuit 107 judges that the signal received by the receiver is not addressed to the own system, and temporarily stops the demodulating process which has tentatively been started.

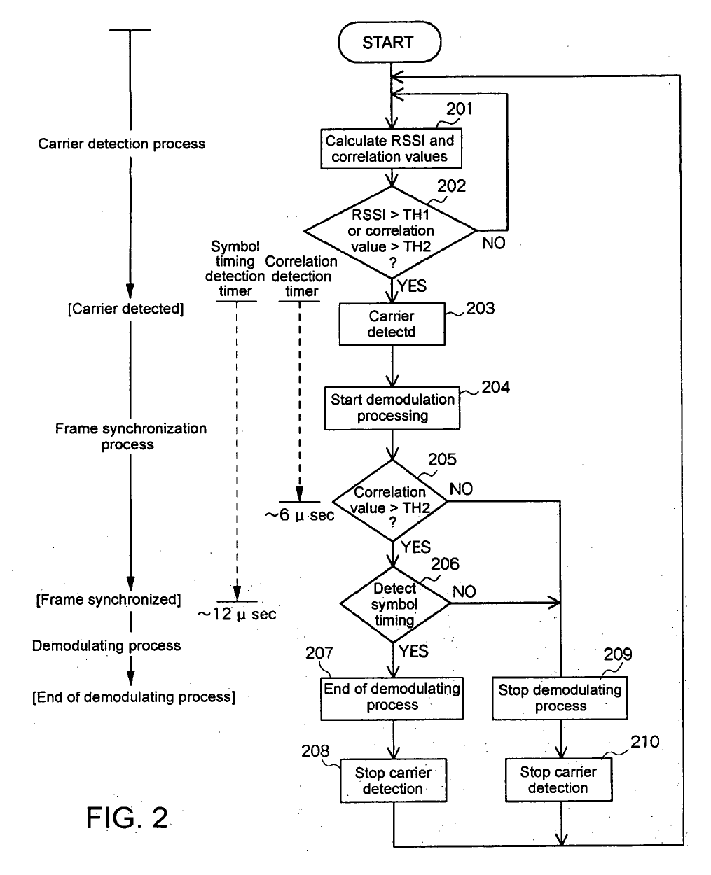

Signal reception operation of the receiver shown in FIG. 1 will be described in chronological order with reference to FIG. 2.

A received signal that has passed through reception filter 101 is supplied to RSSI measuring circuit 102 and correlation detecting circuit 104 in step 201. RSSI measuring circuit 102 calculates an RSSI value, and correlation detecting circuit 104 calculates a correlation value.

In step 202, carrier detection threshold value comparing circuit 103 receives the RSSI value from RSSI measuring circuit 102 and compares the RSSI value with threshold value TH1. Similarly, carrier correlation detection threshold value comparing circuit 105 receives the correlation value from correlation detecting circuit 104 and compares the correlation value with threshold value TH2 if carrier detection threshold value comparing circuit 103 and carrier correlation detection threshold value comparing circuit 105 judge that the RSSI value and the correlation value exceed threshold value TH1 and threshold value TH2, respectively, then each of carrier detection threshold value comparing circuit 103 and carrier correlation detection threshold value comparing circuit 105 delivers a high-level signal “H” to OR circuit 106. Steps 201, 202 are repeated until at least one of carrier detection threshold value comparing circuit 103 and carrier correlation detection threshold value comparing circuit 105 outputs high-level signal “H.”

If at least one of carrier detection threshold value comparing circuit 103 and carrier correlation detection threshold value comparing circuit 105 outputs high-level signal “H” in step 202, then OR circuit 106 tentatively judges, in step 203, that a carrier is detected, and instructs symbol timing detection timer 108 and correlation detection timer 109 to start their counting processes, and instructs demodulating circuit 107 to start the signal demodulating process. Symbol timing detection timer 108 and correlation detection timer 109 are arranged to deliver time elapse signals to demodulating circuit 107 when about 12 microseconds and about 6 microseconds have elapsed therein, respectively.

In step 205, demodulating circuit 107 determines whether it has received a carrier correlation detection signal from carrier correlation detection threshold value comparing circuit 105 or not before it receives the signal representing the elapse of the time of about 6 microseconds from correlation detection timer 109, i.e., whether the correlation value becomes greater than TH2 or not during the time interval of about 6 microseconds. If demodulating circuit 107 has not received a carrier correlation detection signal, then demodulating circuit 107 stops, in step 209, the demodulating process that has been tentatively started. In step 210, it is judged that a carrier is not detected. After step 210, the carrier detecting circuit returns to a waiting state for the received signal, and a new processing cycle is repeated from step 201.

If demodulating circuit 107 has received, in step 205, a carrier correlation detection signal during the time interval of about 6 microseconds, then demodulating circuit 107 determines in step 206 whether a symbol timing is detected or not before it receives the signal representing the elapse of the time of about 12 microseconds from symbol timing detection timer 108. If no symbol timing is detected before demodulating circuit 107 receives the signal representing the elapse of the time of about 12 microseconds from symbol timing detection timer 108 even though it has received a carrier correlation detection signal during the time interval of about 6 microseconds, then control goes to step 209 in which demodulating circuit 107 stops the demodulating process that has been tentatively started. In step 210, it is judged that a carrier is not detected. Thereafter, a new processing cycle is repeated from step 201.

If a symbol timing is detected before the time of about 12 microseconds elapses in step 206, then demodulating circuit 107 continues the demodulating process. Thereafter, the demodulating process is put to an end in step 208. Subsequently, the carrier detecting circuit returns to a waiting state for the received signal, and a new processing cycle is repeated from step 201.

In the receiver shown in FIG. 1, OR circuit 106 may be replaced with an AND circuit, and correlation detection timer 109 may be dispensed with. According to such a modification, demodulating circuit 107 starts the signal demodulating process only if carrier detection threshold value comparing circuit 103 outputs a carrier detection signal and carrier correlation detection threshold value comparing circuit 105 outputs a carrier correlation detection signal. If the received signal is addressed to the own system at this time, then the signal demodulating process is delayed by a time required for carrier correlation detection. However, if the received signal is not addressed to the own system, then any unnecessary demodulating process is not performed at all. With the receiver shown in FIG. 1, since the demodulating process is tentatively started, the starting of the demodulating process is not delayed, but the demodulating process may possibly be needlessly carried out for the time required for carrier correlation detection.

The carrier detecting circuit according to the present embodiment may be implemented by dedicated hardware, or may be implemented by recording a program for performing the functions of the carrier detecting circuit in a computer-readable recording medium, reading the program into a computer which is to serve as the carrier detecting circuit, and executing the read program. The computer-readable recording medium may be a recording medium such as a flexible disk, a magneto-optical disk, a CD-ROM, or the like, or a memory device such as a hard disk drive incorporated in a computer system. Alternatively, the program may be read through a network such as the Internet into the computer.

While a preferred embodiment of the present invention has been described using specific terms, such description is for illustrative purposes only, and it is to be understood that changes and variations may be made without departing from the spirit or scope of the following claims.

1. A method of detecting a carrier in a receiver of a wireless device, comprising the steps of:
determining a power value of a received signal and comparing the power value with a predetermined first threshold value;
determining a correlation value between a preamble included in said received signal and a predetermined preamble pattern which characterizes a communication system to which the wireless device belongs, and comparing said correlation value with a predetermined second threshold value;
judging that a carrier is detected and tentatively starting a demodulating process if said power value exceeds said first threshold value or said correlation value exceeds said second threshold value; and
stopping said demodulating process which has tentatively been started if it is judged that said correlation value does not exceed said second threshold value during a predetermined first time interval from the time when it is judged that a carrier is detected.

2. The method according to claim 1, wherein said predetermined first time interval is shorter than a time required before a symbol time is detected after the carrier is detected.

3. The method according to claim 1, further comprising the step of:
stopping said demodulating process which has tentatively been started if a symbol timing is not detected during a predetermined second time interval from the time when it is judged that a carrier is detected.

4. The method according to claim 1, wherein said power value is calculated from an I component and a Q component of the received signal.

5. A method of detecting a carrier in a receiver of a wireless device, comprising the steps of:
determining a power value of a received signal and comparing the power value with a predetermined first threshold value;
determining a correlation value between a preamble included in said received signal and a predetermined preamble pattern which characterizes a communication system to which the wireless device belongs, and comparing said correlation value with a predetermined second threshold value; and
starting a demodulating process if said power value exceeds said first threshold value and said correlation value exceeds said second threshold value.

6. A carrier detecting circuit provided in a receiver of a wireless device, comprising:
means for determining a power value of a received signal;
means for comparing the power value with a predetermined first threshold value;
means for determining a correlation value between a preamble included in said received signal and a predetermined preamble pattern which characterizes a communication system to which the wireless device belongs;
means for comparing said correlation value with a predetermined second threshold value;
means for judging that a carrier is detected and tentatively instructing a demodulating circuit of the wireless device to start a demodulating process if said power value exceeds said first threshold value or said correlation value exceeds said second threshold value; and
means for instructing said demodulating circuit to stop said demodulating process which has tentatively been started if it is judged that said correlation value does not exceed said second threshold value during a predetermined first time interval from the time when it is judged that a carrier is detected.

7. The circuit according to claim 6, wherein said predetermined first time interval is shorter than a time required before a symbol time is detected after the carrier is detected.

8. The circuit according to claim 6, further comprising:
means for stopping said demodulating process which has tentatively been started if a symbol timing is not detected during a predetermined second time interval from the time when it is judged that a carrier is detected.

9. A carrier detecting circuit provided in a receiver of a wireless device, comprising:
means for determining a power value of a received signal;
means for comparing the power value with a predetermined first threshold value;
means for determining a correlation value between a preamble included in said received signal and a predetermined preamble pattern which characterizes a communication system to which the wireless device belongs;
means for comparing said correlation value with a predetermined second threshold value; and
means for instructing a demodulating circuit of the wireless device to start a demodulating process if said power value exceeds said first threshold value and said correlation value exceeds said second threshold value.

10. A receiver for a wireless device, comprising:
a demodulating circuit;
means for determining a power value of a received signal;
means for comparing the power value with a predetermined first threshold value;
means for determining a correlation value between a preamble included in said received signal and a predetermined preamble pattern which characterizes a communication system to which the wireless device belongs;
means for comparing said correlation value with a predetermined second threshold value;
means for judging that a carrier is detected and tentatively instructing a demodulating circuit to start a demodulating process if said power value exceeds said first threshold value or said correlation value exceeds said second threshold value; and
means for measuring a predetermined first time interval from the time when it is judged that a carrier is detected;
wherein said demodulating process which has tentatively been started is stopped if it is judged that said correlation value does not exceed said second threshold value during said predetermined first time interval.

11. The receiver according to claim 10, further comprising:
means for measuring a predetermined second time interval, longer than said predetermined first time interval, from the time when it is judged that a carrier is detected;
wherein said demodulating process which has tentatively been started is stopped if said demodulating circuit does not detect a symbol timing during said predetermined second time interval.
